(19) United States
(12) Patent Application Publication
(10) Pub. No.: US 2021/0151761 A1
(43) Pub. Date: May 20, 2021

(54) ELECTRODE AND COMPOSITION HAVING TAILORED POROSITY FOR A LITHIUM-ION ELECTROCHEMICAL CELL

(71) Applicant: GM GLOBAL TECHNOLOGY OPERATIONS LLC, Detroit, MI (US)

(72) Inventors: Niccolo Jimenez, Troy, MI (US); Ion C. Halalay, Grosse Pointe Park, MI (US); Michael P. Balogh, Novi, MI (US); Raghunathan K, Troy, MI (US)

(73) Assignee: GM GLOBAL TECHNOLOGY OPERATIONS LLC, Detroit, MI (US)

(21) Appl. No.: 16/686,427

(22) Filed: Nov. 18, 2019

(51) Int. Cl. H01M 4/62; H01M 10/0525; H01M 4/04

(52) U.S. Cl. CPC H01M 4/622; H01M 10/0525; H01M 2004/021; H01M 4/624; H01M 4/0435

(57) ABSTRACT

An electrode for a lithium-ion electrochemical cell includes a current collector and a first layer formed from a first electrode composition disposed on the current collector. The first electrode composition includes a binder component; a conductive filler component dispersed within the binder component; and an active material component dispersed within the binder component and the conductive filler component. The first electrode composition has a first surface and a second surface spaced apart from and parallel to the first surface. The first electrode composition defines a plurality of pores between the first surface and the second surface having a tailored pore size distribution that includes at least a first pore size and a second pore size that is greater than the first pore size. The first electrode composition has a first porosity of at least 60%.

### INTRODUCTION

The disclosure relates to an electrode for a lithium-ion electrochemical cell and to a method of forming the electrode.

Electrochemical cells or batteries are useful for converting chemical energy into electrical energy, and may be primary or secondary. Primary batteries are generally non-rechargeable, whereas secondary batteries are readily rechargeable and may be restored to a full charge after use. As such, secondary batteries may be useful for applications such as powering electronic devices, tools, machinery, and vehicles.

One type of secondary battery, a lithium-ion secondary battery, may include a negative electrode or anode, a positive electrode or cathode, and a separator disposed between the positive and negative electrodes. The negative electrode may be formed from a material that is capable of incorporating and releasing lithium ions during charging and discharging of the lithium-ion secondary battery. During charging of the lithium-ion secondary battery, lithium ions may move from the positive electrode to the negative electrode and embed, e.g., by intercalation, insertion, substitutional solid solution strengthening, or other means, in the material. Conversely, during battery discharge, lithium ions may be released from the material and move from the negative electrode to the positive electrode.

### SUMMARY

An electrode for a lithium-ion electrochemical cell includes a current collector and a first layer formed from a first electrode composition disposed on the current collector. The first electrode composition includes a binder component; a conductive filler component dispersed within the binder component; and an active material component dispersed within the binder component and the conductive filler component. The first electrode composition has a first surface and a second surface spaced apart from and parallel to the first surface. The first electrode composition defines a plurality of pores between the first surface and the second surface having a tailored pore size distribution that includes at least a first pore size and a second pore size that is greater than the first pore size. The first electrode composition has a first porosity of at least 60%.

In one aspect, the plurality of pores may form a porosity gradient within the first electrode composition between the first surface and the second surface that is configured to minimize an expansion of the electrode and accommodate silicon particle growth during cycling of the lithium-ion electrochemical cell.

In another aspect, the plurality of pores may be randomly arranged between the first surface and the second surface.

In a further aspect, the first electrode composition may have a substantially uniform thickness from the first surface to the second surface.

In an additional aspect, the binder component may be present in the first electrode composition in a first amount; the conductive filler component may be present in the first electrode composition in a second amount; and the active material component may be present in the first electrode composition in a third amount that is greater than the first amount and the second amount.

In yet another aspect, the electrode may further include a second layer formed from a second electrode composition and disposed adjacent the first layer.

In one aspect, the second electrode composition may include a second active material component that is present in the second electrode composition in a fourth amount that is different from the third amount.

In another aspect, the second electrode composition may have a second porosity that is different from the first porosity.

A method of forming an electrode for a lithium-ion electrochemical cell includes mixing together a conductive filler component; an active material component; a rheology modifier component; and a binder solution that includes a binder component and a solvent to disperse the conductive filler component, the active material component, and the rheology modifier component within the binder solution and form a slurry. The method also includes casting the slurry onto a current collector to form a wet workpiece, and contacting the wet workpiece with a non-solvent to thereby induce a phase inversion and form a wet electrode composition. The method further includes drying the wet electrode composition to form a first electrode composition disposed on the current collector and thereby form the electrode. The first electrode composition has a first surface and a second surface spaced apart from and parallel to the first surface. The first electrode composition defines a plurality of pores between the first surface and the second surface having a tailored pore size distribution that includes at least a first pore size and a second pore size that is greater than the first pore size. The first electrode composition has a first porosity of at least 60%.

In one aspect, contacting and inducing the phase inversion may include forming a liquid-like polymer lean phase and a solid-like polymer rich phase in the wet electrode composition as the non-solvent enters the slurry.

In another aspect, drying may include removing the liquid-like polymer lean phase from the wet electrode composition to thereby define the plurality of pores.

In a further aspect, contacting may include submersing the slurry in a bath including the non-solvent.

In an additional aspect, contacting may include misting the slurry with the non-solvent in a chamber for a residence time.

In yet another aspect, the method may further include, prior to drying the wet electrode composition, subjecting the wet electrode composition to a vacuum at a temperature of from 20° C. to 150° C.

In one aspect, drying the wet electrode composition may include pyrolyzing the wet electrode composition at from 350° C. to 950° C. in a nitrogen atmosphere.

In another aspect, mixing may include blending together the conductive filler component, the active material component, the rheology modifier component, and the binder solution for from 3 minutes to 10 minutes.

In a further aspect, the method may also include, after drying, calendaring the first surface to modify the first porosity of the electrode.

A method of forming an electrode for a lithium-ion electrochemical cell includes mixing together a conductive filler component; an active material component; a sacrificial polymer component; and a binder solution that includes a binder component and a solvent to disperse the conductive filler component, the active material component, and the sacrificial polymer component within the binder solution and form a slurry. The method also includes casting the slurry onto a current collector to form a wet workpiece, and drying the wet workpiece to thereby form a first electrode composition disposed on the current collector. The first electrode composition has a first surface and a second surface spaced apart from and parallel to the first surface. The first electrode composition defines a plurality of pores between the first surface and the second surface having a tailored pore size distribution that includes at least a first pore size and a second pore size that is greater than the first pore size. The first electrode composition has a first porosity of at least 60%. The method also includes heat-treating the first electrode composition to thereby form the electrode.

In one aspect, heat-treating may include cyclizing the binder component.

In another aspect, heat-treating may include pyrolyzing the first electrode composition to remove the sacrificial polymer from the first electrode composition.

The above features and advantages and other features and advantages of the present disclosure will be readily apparent from the following detailed description of the preferred embodiments and best modes for carrying out the present disclosure when taken in connection with the accompanying drawings and appended claims.

### BRIEF DESCRIPTION OF THE DRAWINGS

FIG. 1 is a schematic illustration of an exploded perspective view of a lithium-ion electrochemical cell including an electrode.

FIG. 2 is a schematic illustration of a cross-sectional view of a device including the lithium-ion electrochemical cell of FIG. 1.

FIG. 3 is a flowchart of a method of forming the electrode of FIG. 1.

FIG. 4 is a schematic illustration of a side view of a portion of the method of FIG. 3.

FIG. 5 is a schematic illustration of a cross-sectional view of an electrode composition during formation of the electrode of FIG. 1.

FIG. 6 is a schematic illustration of a side view of another portion of the method of FIG. 3

FIG. 7 is a flowchart of another embodiment of the method of FIG. 3.

### DETAILED DESCRIPTION

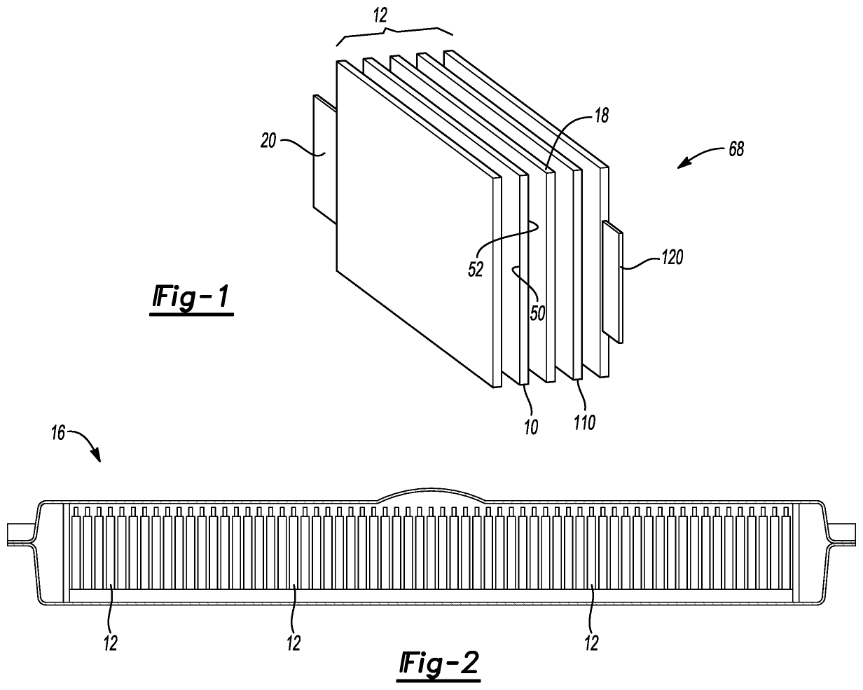

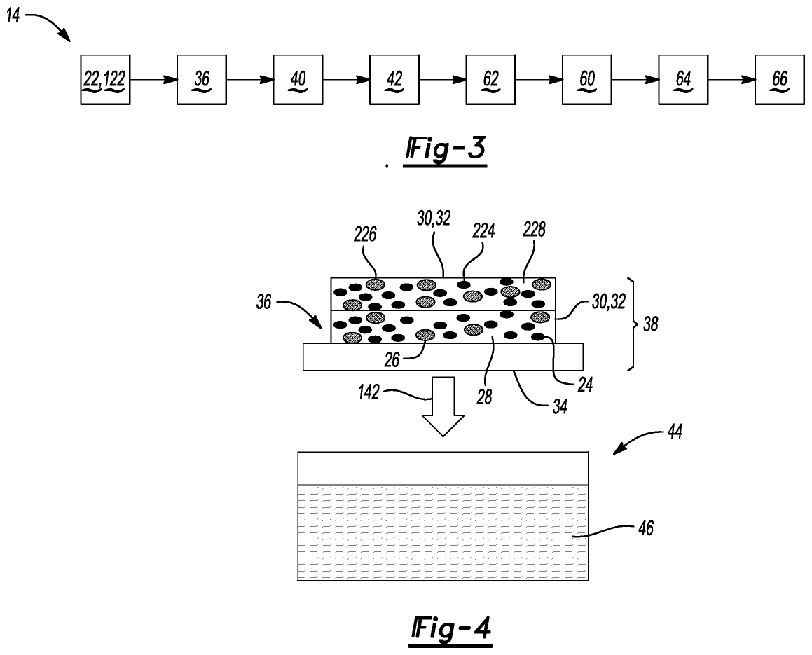

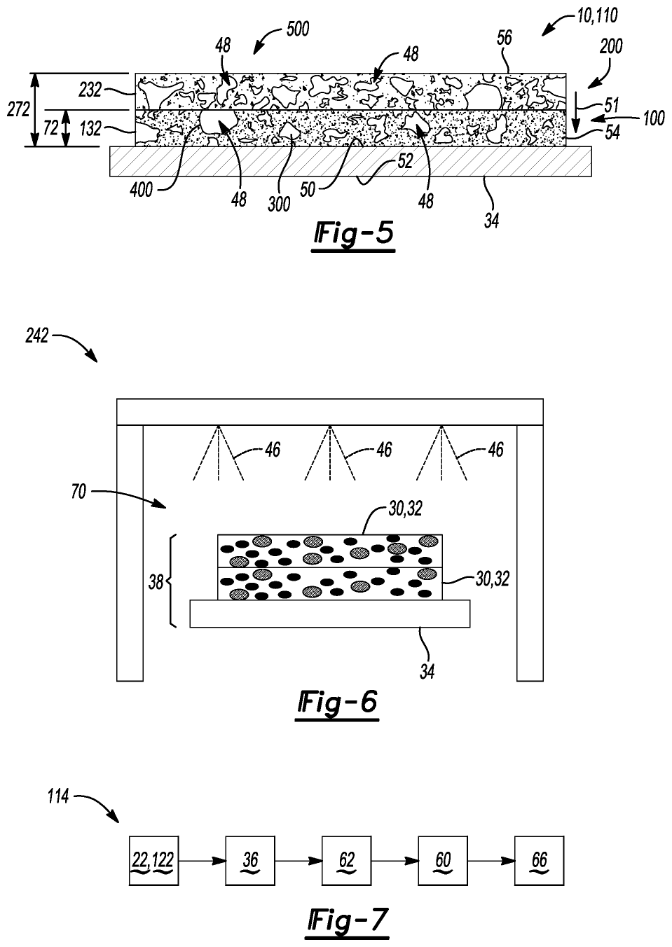

Referring to the Figures, wherein like reference numerals refer to like elements, an electrode 10, 110 for a lithium-ion electrochemical cell 12 is shown generally in FIG. 1, and a method 14, 114 for forming the electrode 10 is shown generally in FIGS. 3 and 7. The electrode 10, 110, lithium-ion electrochemical cell 12, and method 14, 114 may be useful for applications requiring lithium-ion electrochemical cells 12 having excellent electrode porosity, energy density, operating life, power performance, and charging speed. In particular, and as set forth in more detail below, the electrode 10, 110 may have a comparatively high porosity, a tailored porosity gradient 500 (FIG. 5), a layered composition, and/or a layered porosity. Further, the method 14, 114 may be simplified as compared to other manufacturing methods and scalable to mass production operations. Specifically, the method 14, 114 may employ solvent extraction with water and a precipitation of a polymer binder, and/or may employ rheology modifiers or sacrificial polymers to form the electrode 10, 110. Therefore, the electrode 10, 110 and lithium-ion electrochemical cell 12 may be economical in terms of manufacturing time and cost.

As such, the electrode 10, 110, lithium-ion electrochemical cell 12, and method 14, 114 may be useful for vehicular applications such as, but not limited to, automobiles, buses, forklifts, motorcycles, bicycles, trains, trams, trolleys, spacecraft, airplanes, farming equipment, earthmoving or construction equipment, cranes, transporters, boats, and the like. Alternatively, the electrode 10, 110, lithium-ion electrochemical cell 12, and method 14, 114 may be useful for non-vehicular applications such as household and industrial power tools, residential appliances, electronic devices, computers, and the like. By way of a non-limiting example, the electrode 10, 110, lithium-ion electrochemical cell 12, and method 14, 114 may be useful for powertrain applications for non-autonomous, autonomous, or semi-autonomous vehicle applications.

Referring now to FIG. 1, the lithium-ion electrochemical cell 12 may be a secondary or rechargeable battery configured for converting energy and providing power to a device 16 (FIG. 2). That is, the device 16 may include the lithium-ion electrochemical cell 12. In one example, the device 16 may be a secondary battery module or pack configured for operation by electron transfer.

Therefore, the device 16 or secondary battery module may be useful for automotive applications, such as for a plug-in hybrid electric vehicle (PHEV). For example, the secondary battery module may be a lithium-ion secondary battery module. Further, although not shown, a plurality of secondary battery modules may be combined to form a secondary battery or pack. That is, the secondary battery module may be connected to one or more other secondary battery modules to form the secondary battery. By way of example, the secondary battery module may be sufficiently sized to provide sufficient voltage for powering a hybrid electric vehicle (HEV), an electric vehicle (EV), a plug-in hybrid electric vehicle (PHEV), and the like, e.g., approximately 300 to 400 Volts or more, depending on the required application. Alternatively, although not shown, the device 16 may be a vehicle and may include a plurality of lithium-ion electrochemical cells 12.

Further, as shown in FIG. 1, the lithium-ion electrochemical cell 12 may include a negative electrode 10 (or anode), a positive electrode 110 (or cathode) spaced apart from the negative electrode 10, and an electrolyte solution-filled separator 18 disposed between the positive electrode 110 and the negative electrode 10. That is, the electrode 10 may be the anode. Alternatively, the electrode 110 may be the cathode. In addition, the lithium-ion electrochemical cell 12 may have a positive electrode tab 120 and a negative electrode tab 20, and the lithium-ion electrochemical cell 12 may be suitable for stacking. That is, the lithium-ion electrochemical cell 12 may be packaged in a heat-sealable flexible metallized multilayer polymeric foil, or inside a metal can, that is sealed to enclose the positive electrode 110, the negative electrode 10, and the electrolyte solution-filled separator 18. Therefore, a number of lithium-ion electrochemical cells 12 may be stacked or otherwise placed adjacent to each other to form a cell stack, i.e., the secondary battery module or pack illustrated generally in FIG. 2. The actual number of lithium-ion electrochemical cells 12 may be expected to vary with the required voltage output of each secondary battery module. Likewise, the number of interconnected secondary battery modules may vary to produce the total output voltage for a specific application.

Referring again to FIG. 2, the device 16 may include the lithium-ion electrochemical cell 12. The lithium-ion electrochemical cell 12 may incorporate lithium iron phosphate, lithium vanadium pentoxide, lithium manganese dioxide, a mixed lithium-manganese-nickel oxide, a mixed lithium-nickel-cobalt oxide, a mixed lithium-manganese-nickel-cobalt oxide, and combinations thereof as a material for the positive electrode 110 (FIG. 1). The lithium-ion electrochemical cell 12 may incorporate, for example, graphite, amorphous carbon, lithium titanate, silicon, silicon oxide, tin, tin oxide, and combinations thereof as a material for the negative electrode 10 (FIG. 1).

Referring now to FIG. 3, the method 14 of forming the electrode 10, 110 includes mixing 22 together a conductive filler component 24 (FIG. 4), an active material component 26 (FIG. 4), a rheology modifier component (not shown), and a binder solution that includes a binder component 28 (FIG. 4) and a solvent to disperse the conductive filler component 24, the active material component 26, and the rheology modifier component within the binder solution and form a slurry 30 (FIG. 4). For example, mixing 22 may include blending together the conductive filler component 24, the active material component 26, the rheology modifier component, and the binder solution for from 3 minutes to 10 minutes, or from 4 minutes to 7 minutes, or for 5 minutes. After completion of mixing 22, the conductive filler component 24, the active material component 26, and the rheology modifier component are dispersed within the binder solution to form the slurry 30. Then, during additional processing described below, the slurry 30 is disposed on a current collector 34 (FIG. 4) to eventually form the electrode 10, 110.

As described with reference to FIG. 4, the conductive filler component 24 may include a conductive carbon. Suitable conductive carbon may be selected for electrical conductivity and may include, but is not limited to, carbon black, carbon fibers, carbon nanofibers, carbon nanotubes, graphite, graphene, and combinations thereof. For example, the conductive filler component 24 may include vapor grown carbon fibers to provide the electrode 10, 110 with excellent stiffness and elasticity. In another example, the conductive filler component 24 may include single-wall carbon nanotubes to provide electrical contact points with the active material component 26 and an electronic conduction path to the current collector 34 (FIG. 4), even if the active material component 26 degrades during electrochemical cycling of the lithium-ion electrochemical cell 12. In another example, the conductive filler component 24 may include graphene sheets to provide the electrode 10, 110 with excellent stiffness, elasticity, and electronic conduction paths. In a further example, the conductive filler component 24 may include graphite particles to provide the electrode 10, 110 with lubrication and electronic conduction paths. The conductive filler component 24 may form an electrically-conductive network within the formed electrode 10, 110. In particular, the electrically-conductive network may be a contiguous network of carbon electrically connected to the active material component 26.

As described with continued reference to FIG. 4, the active material component 26 may be silicon, a silicon oxide, a silicon alloy, tin, or a tin alloy. In one embodiment, the active material component 26 may include silicon nanoparticles and/or silicon micron-sized particles. Further, the active material component 26 may include a plurality of active material particles coated with carbon and/or copper. That is, the copper or a mixture of copper and carbon may form a protective coating on a surface of each of the active material particles to form the active material component 26. For example, the active material component 26 may include nano- or micron-sized silicon particles or nano-porous micron-sized silicon particles coated with the protective coating of copper. In particular, the protective coating may form a film on the surface of the active material particles that may lessen parasitic reactions which may consume electrolyte during operation of the lithium-ion electrochemical cell 12.

The rheology modifier component may include a foaming or blowing agent, such as a polyurethane foaming or blowing agent; a thickening agent; a surfactant; an emulsifying agent; and combinations thereof. The rheology modifier component may be present in the slurry 30 to modify a first porosity 100 (FIG. 5) of a first electrode composition 132 formed from the slurry 30 during a solvent-extraction and phase inversion process of the method 14, as set forth in more detail below. In particular, the first porosity 100 may be at least 60% such that the electrode 10, 110 may be characterized as a highly porous electrode 10, 110 that accommodates large irreversible volume expansion of silicon during operation of the lithium-ion electrochemical cell 12. As such, the claimed embodiments may minimize deterioration of the electrode 10, 110 due to expansion and may prolong a cycle life of the electrode 10, 110 and lithium-ion electrochemical cell 12.

In particular, the rheology modifier component may contribute to the excellent first porosity 100 of the first electrode composition 132 and electrode 10, 110 and may optimize pore structure uniformity. The rheology modifier component may be present in the slurry 30 in an amount of from 0.5 parts by weight to 30 parts by weight based on 100 parts by weight of the slurry 30. For example, the rheology modifier component may be present in the slurry 30 in an amount of from 5 parts by weight to 20 parts by weight, or from 10 parts by weight to 15 parts by weight, based on 100 parts by weight of the slurry 30. At amounts outside the aforementioned range, the first electrode composition 132 may not exhibit the excellent first porosity 100 of the claimed embodiments.

The binder component 28 (FIG. 4) may include, for example, a polyimide or a polyacrylonitrile or polyvinylidene fluoride. The binder component 28 may be dispersed in the solvent, such as, but not limited to, N-methyl-2-pyrrolidone to form the binder solution. Although the solvent is removed from the electrode 10, 110 during subsequent processing as set forth below, the binder component 28 may bind or glue the electrode 10, 110 together and may provide mechanical stability to electrical contact points between the conductive filler component 24, e.g., single wall carbon nanotubes, the active material component 26, and the rheology modifier component. In addition, adjusting an amount of the solvent in the binder solution may enable tuning of the first porosity 100 of the electrode 10, 110. Suitable compounds, polymer binders, or polymer precursors may include, but are not limited to, nitrogen-containing compounds and polymers such as polyimides, polyamic acid, phenolic resins, epoxy resins, polyethyleneimines, polyacrylonitrile, melamine, cyanuric acid, polyamides, polyvinylidene fluoride, and combinations thereof. Suitable solvents may include, but are not limited to, N-methyl-2-pyrrolidone, dimethylformamide, dimethyl sulfoxide, methanol, ethanol, isopropanol, acetone, water, and combinations thereof.

In one specific embodiment, the binder component 28 may include a polyimide or a polyacrylonitrile or polyvinylidene fluoride, the conductive filler component 24 may include carbon, and the active material component 26 may include silicon, e.g., silicon nanoparticles and silicon micron-sized particles.

As set forth in more detail below, the electrode 10, 110 includes a current collector 34 and a first electrode composition 132 disposed on the current collector 34. For the electrode 10, 110, the binder component 28 may be present in the first electrode composition 132 in a first amount; the conductive filler component 24 may be present in the first electrode composition 132 in a second amount; and the active material component 26 may be present in the first electrode composition 132 in a third amount that is greater than the first amount and the second amount. For example, the binder component 28 may be present in the first electrode composition 132 in an amount of from 3 parts by weight to 40 parts by weight, or from 10 parts by weight to 30 parts by weight, or from 20 parts by weight to 25 parts by weight, based on 100 parts by weight of the first electrode composition 132. The conductive filler component 24 may be present in the first electrode composition 132 in an amount of from 2 parts by weight to 50 parts by weight, or from 10 parts by weight to 40 parts by weight, or from 30 parts by weight to 35 parts by weight, based on 100 parts by weight of the first electrode composition 132. The active material component 26 may be present in the first electrode composition 132 in an amount of from 30 parts by weight to 95 parts by weight, or from 40 parts by weight to 80 parts by weight, or from 50 parts by weight to 60 parts by weight, based on 100 parts by weight of the first electrode composition 132. At amounts outside the aforementioned ranges, the electrode 10, 110 may not exhibit the excellent first porosity 100, energy density, operating life, power performance, and charging speed of the claimed embodiments.

Referring again to FIG. 3, the method 14 of forming the electrode 10, 110 also includes casting 36 the slurry 30 onto the current collector 34 (FIG. 4) to form a wet workpiece 38 (FIG. 4). For example, casting 36 may include extruding or bar coating or knife coating or slot die coating the slurry 30 onto the current collector 34. In one embodiment, casting 36 may include applying the slurry 30 to the current collector 34 with a flat blade (not shown) spaced apart from the current collector 34 at a controlled distance, such that the flat blade spreads the slurry 30 over the current collector 34. Further, casting 36 the slurry 30 may be continuous or may be a batch process or a semi-batch process.

The current collector 34 may be a suitable copper matrix. For example, the current collector 34 may be a solid sheet formed from copper. Alternatively, the current collector 34 may be a foil formed from copper and may define a plurality of perforations or slits therein. Alternatively, the current collector 34 may be a woven mesh made from copper. In other embodiments, the current collector 34 may be a copper foam. In other embodiments, the current collector 34 may be a nickel or stainless steel or aluminum foil.

Alternatively, in some instances, the method 14 may include, after mixing 22 and prior to casting 36, remixing 122 (FIG. 3) the slurry 30. That is, after mixing 22 together the active material component 26, the conductive filler component 24, the rheology modifier component, and the binder solution including the binder component 28 and the solvent for about 5 minutes, the method 14 may include remixing 122 the components 26, 24, 28 and the rheology modifier component in the presence of the solvent for an additional time, e.g., an additional 5 minutes, to ensure adequate dispersion of the active material component 26, the conductive filler component 24, and the rheology modifier component within the binder solution.

Additionally, the method 14 may further include, after mixing 22, resting 40 the wet workpiece 38 for from 0.1 minutes to 4 minutes in air. For example, resting 40 the wet workpiece 38 in air may allow the slurry 30 to settle and spread along the current collector 34.

Referring again to FIG. 3, the method 14 also includes contacting 42 the wet workpiece 38 with a non-solvent 46 to thereby induce a phase inversion and form a wet electrode composition 32. That is, the solvent and the non-solvent 46 may be soluble in one another so that the non-solvent 46 may remove the solvent from the wet electrode composition 32, as set forth in more detail below. After contacting 42 the non-solvent 46 and the solvent, the wet electrode composition 32 may include the conductive filler component 24, the active material component 26, the polymer binder component 28, and a comparatively small amount of the non-solvent 46. Suitable non-solvents 46 may include, but are not limited to, water and aliphatic, semi-aromatic, or aromatic alcohols. For example, suitable examples of the non-solvent 46 may include water; alcohols such as isopropyl alcohol, glycol, and methanol; hexanes; and combinations thereof.

In particular, contacting 42 and inducing the phase inversion may include forming a liquid-like polymer lean phase and a solid-like polymer rich phase in the wet electrode composition 32 as the non-solvent 46 enters the slurry 30. As set forth in more detail below, the phase inversion process may be specifically useful for generating a favorable arrangement of pores 48 (FIG. 5), i.e., the first porosity 100, within the first electrode composition 132 to thereby facilitate optimal lithium ion transport during operation of the lithium-ion electrochemical cell 12, excellent cycle-to-cycle capacity retention, optimal accommodation for silicon expansion during cycling without disturbing electrical connections, improved thickness uniformity and surface roughness of the electrode 10, 110, and excellent resistance to electrolyte dryout since the pores 48 have comparatively more volume. That is, the favorable arrangement of pores 48 may create the excellent first porosity 100 that accommodates silicon expansion during cycling of the lithium-ion electrochemical cell 12 without damaging electrical connections within the electrode 10, 110. In addition, the favorable arrangement of pores 48 may promote lithium ion transport during operation, which provides fast-charging capability and excellent power performance of the lithium-ion electrochemical cell 12.

In one aspect best shown in FIG. 4, contacting 42 may include submersing 142 the wet workpiece 38 in a bath 44 that includes a non-solvent 46 to thereby contact the non-solvent 46 and the solvent, induce the phase inversion, and form the wet electrode composition 32. Submersing 142 may include inducing the phase inversion process in which the wet electrode composition 32 converts to the liquid-like polymer lean phase and the solid-like polymer rich phase upon contact of the slurry 30 with the non-solvent 46. In one embodiment, the non-solvent 46 may be water, and lithium-ion electrochemical cells 12 including the electrode 10, 100 may exhibit excellent capacity retention during cycling as compared to cells that include electrodes formed by solvent evaporation or other methods. In particular, electrodes 10, 110 formed by contact with the non-solvent 46, e.g., water, may experience a comparatively smaller change in an overall thickness 72, 272 (FIG. 5) and a comparatively smaller mass change per cycle during electrochemical cycling as compared to electrodes formed via solvent evaporation in air. Stated differently, the electrodes 10, 110 of the claimed embodiments may be pre-expanded and may not undergo undesirable expansion during operation of the lithium-ion electrochemical cell 12.

In another aspect best shown in FIG. 6, contacting 42 may include misting 242 the slurry 30 with the non-solvent 46 in a chamber 70 for a residence time. For example, misting 242 may include passing the wet workpiece 38 through the chamber 70 for a desired residence time that may be preselected or varied to tailor the first porosity 100 of the first electrode composition 132. In particular, the chamber 70 may define an enclosed space in which the non-solvent 46 in mist form may be sprayed onto the wet workpiece 38 such that the non-solvent 46 contacts the slurry 30 and induces the phase inversion as set forth above.

Referring again to FIG. 5, the method 14 also includes drying 60 the wet electrode composition 32 to form the first electrode composition 132 disposed on the current collector 34 and thereby form the electrode 10, 110. Drying 60 may include removing any residual water or non-solvent 46 after the phase inversion process. For example, drying 60 the wet electrode composition 32 may include first heating the wet electrode composition 32 at from room temperature, or from about 20° C. to about 25° C., to about 150° C., or from about 80° C. to about 120° C., to remove any water or non-solvent 46 after the phase inversion process, and then pyrolyzing the wet electrode composition 32 at from 350° C. to 950° C., or from 475° C. to 925° C., or at about 800° C. in a nitrogen environment to form the dried first electrode composition 132 disposed on the current collector 34 and thereby form the electrode 10, 110. In addition, as shown in FIG. 5, the method 14 may further include, prior to drying 60 the wet electrode composition 32, subjecting 62 the wet electrode composition 32 to a vacuum at a temperature of from 20° C. to 150° C., or from 75° C. to 100° C., to further prepare the wet electrode composition 32 for drying 60. Alternatively, the method 12 may include, after drying 60 the wet electrode composition 32, exposing the formed first electrode composition 132 to a vacuum at a temperature greater than ambient temperature to further dry the first electrode composition 132.

Further, drying 60 may include removing the liquid-like polymer lean phase from the wet electrode composition 32 to thereby define the plurality of pores 48. More specifically, during drying 60, the non-solvent 46 may be removed from the wet electrode composition 32 to thereby define the plurality of pores 48 (FIG. 5) within the first electrode composition 132 between the surfaces 50, 52 of the electrode 10, 110, e.g., randomly arranged or disposed between the surfaces 50, 52, as described in more detail below. In other words, when the surfaces 50, 52 are disposed as a top and bottom, respectively, of the electrode 10, 110, the first direction 51 may be a vertical direction such that the plurality of pores 48 may be disposed vertically between the surfaces 50, 52. That is, contacting 42 may include inducing the phase inversion process in which the wet electrode composition 32 converts to the liquid-like polymer lean phase and the solid-like polymer rich phase, and drying 60 may include removing the liquid-like polymer lean phase to thereby define the plurality of pores 48 (FIG. 5) in the first electrode composition 132.

In particular, contacting 42 may include soaking the slurry 30 in the non-solvent 46 and drying 60 may include removing the liquid-like polymer lean phase to thereby define the plurality of pores 48. That is, once the liquid-like polymer lean phase and the solid-like polymer rich phase are formed during soaking in the bath 44 (FIG. 4) or during misting 242 (FIG. 6), the liquid-like polymer lean phase may be removed during drying 60 to thereby define the plurality of pores 48. More specifically, the solid-like polymer rich phase may be a continuous phase and the plurality of pores 48 may be defined in the first electrode composition 132. However, if the solid-like polymer rich phase is discontinuous, solid particles may be present. Therefore, contacting 42 may form a continuous solid-like polymer rich phase in the wet electrode composition 32.

Referring now to FIG. 5, the first electrode composition 132 formed after drying 60 includes a first surface 50 and a second surface 52 spaced apart from and parallel to the first surface 50. Further, the first electrode composition 132 may have a substantially uniform thickness 72, 272 between the first surface 50 and the second surface 52 and may be thicker than a graphite-based electrolyte. Therefore, as compared to a relatively thin electrode, the electrode 10, 110 may accommodate comparatively more electrolyte solution and minimize dryout of the electrode 10, 110 during operation of the lithium-ion electrochemical cell 12. That is, drying 60 the wet electrode composition 32 may form the first electrode composition 132 having the first surface 50 and the second surface 52 spaced apart from and parallel to the first surface 50.

In addition, as best shown in FIG. 5, the first electrode composition 132 defines the plurality of pores 48 therein between the first surface 50 and the second surface 52 having a tailored pore size distribution that includes at least a first pore size 300 and a second pore size 400 that is greater than the first pore size 300. For example, the first pore size 300 may be from a quarter to three quarters, or from a quarter to a half, of the second pore size 400. That is, the first electrode composition 132 may define pores 48 having a comparatively larger size than, for example, a graphite-based electrolyte.

Further, the first electrode composition 132 has the first porosity 100 of at least 60%. For example, the first porosity 100 may be 65% or 70% or 75% or 80% or 85% or 90% according to a desired capability of the electrode 10, 110. Generally, a comparatively higher first porosity 100 may better accommodate silicon expansion during cycling of the lithium-ion electrochemical cell 12. Further, a comparatively higher first porosity 100 may facilitate optimal lithium ion transport during operation of the lithium-ion electrochemical cell 12, excellent cycle-to-cycle capacity retention, improved thickness uniformity and reduced surface roughness of the electrode 10, 110, and excellent resistance to electrolyte 18 dryout since the pores 48 have comparatively more volume. That is, the favorable arrangement of pores 48 may promote lithium ion transport during operation, which provides fast-charging capability and excellent power performance of the lithium-ion electrochemical cell 12.

In addition, the plurality of pores 48 may promote the tailored pore size distribution within the first electrode composition 132 between the first surface 50 and the second surface 52 that is configured to accommodate silicon expansion during operation of the lithium-ion electrochemical cell 12. Such silicon expansion and tailored pore size distribution enables fast charging and excellent energy and power performance of the lithium-ion electrochemical cell 12. In one example, the plurality of pores 48 may form a porosity gradient 500 within the first electrode composition 132 between the first surface 50 and the second surface 52 that is configured to minimize an expansion of the electrode 10, 110 and accommodate silicon particle growth during cycling of the lithium-ion electrochemical cell 12. That is, the plurality of pores 48 may be randomly arranged between the first surface 50 and the second surface 52 such that the porosity gradient 500 changes, e.g., increases or decreases, along the first direction 51. Stated differently, the first porosity 100 may vary along the first direction 51. In one non-limiting example, the porosity gradient 500 may be continuously variable along the first direction 51. Alternatively, the first porosity 100 may be expressed as an average of the porosity gradient 500.

In addition, each of the plurality of pores 48 may be arranged adjacent to a lithium transport tunnel or channel or passageway (not shown). For example, the plurality of pores 48 may be arranged adjacent to an entirety of and/or an entrance to or exit from to one or more channels defined within the first electrode composition 132. As such, the plurality of pores 48 may be randomly arranged or located between the first surface 50 and the second surface 52 to promote excellent lithium ion transport and silicon expansion during cycling of the lithium-ion electrochemical cell 12.

In some instances, the method 14 may also include, after drying 60 at from room temperature to about 150° C., calendaring 64 the first surface 50 and/or the second surface 52 to modify the first porosity 100 of the first electrode composition 132 and electrode 10, 110. For example, calendaring 64 may include pressing the electrode 10, 110 between two rollers (not shown) in a continuous process to smooth the first surface 50 and/or the second surface 52 and optimize the first porosity 100 of the electrode 10, 110. Similarly, the method 14 may include sanding or buffing the first surface 50 and/or the second surface 52 to remove any compacted material that may block or alter a shape of individual ones of the plurality of pores 48. The rollers may be formed from, for example, polytetrafluoroethylene-impregnated hard-anodized aluminum, polytetrafluoroethylene-coated brass, polytetrafluoroethylene-coated copper, polytetrafluoroethylene-coated stainless steel, polytetrafluoroethylene-coated nickel, polytetrafluoroethylene-coated nickel alloys, and combinations thereof. Calendaring 64 may therefore harden, flatten, and further dry the first electrode composition 132.

In some embodiments, the method 14 may also include, after calendaring 64, heat-treating 66 the first electrode composition 132. Heat-treating 66 may include cyclizing the binder component, e.g., the polyacrylonitrile. Further, heat-treating 66 may include pyrolyzing the first electrode composition 132 to remove the sacrificial polymer component from the first electrode composition 132. Finally, the method 14 may include fabricating 68 (FIG. 1) the lithium-ion electrochemical cell 12 to include the electrode 10, 110.

Referring now to FIG. 5, in some embodiments, the electrode 10, 110 may further include a second layer 56 formed from a second electrode composition 232 and disposed adjacent the first layer 54. That is, the electrode 10, 110 may be multi-layered. Further, the second electrode composition 232 may include a second active material component 226 (FIG. 4) that is present in the second electrode composition 232 in a fourth amount that is different from the third amount. That is, the electrode 10, 110 may have a layered composition. Additionally or alternatively, the second electrode composition 232 may have a second porosity 200 that is different from the first porosity 100. That is, the electrode 10, 110 may have a layered porosity that varies from layer 54 to layer 56.

For these embodiments, the second layer 56 may be formed on top of the first layer 54 by casting 36 additional slurry 30 or slurry 30 having different components 224, 226, 228 onto the first layer 54 once the first electrode composition 132 is formed by drying 60. That is, the electrode 10, 110 may be additively manufactured by casting 36 one or more additional layers 56 onto the first layer 54. Stated differently, a multilayered electrode 10, 110 may be created by successive casting 36 and passes though the chamber 70 or by successive casting 36 and submersion in the bath 44.

Referring now to FIG. 7, in another embodiment, the method 114 includes mixing 22 together the conductive filler component 24, the active material component 26, a sacrificial polymer component, and the binder solution including the binder component 28 and the solvent to disperse the conductive filler component 24, the active material component 26, and the sacrificial polymer component within the binder solution and form the slurry 30, as set forth above. After casting 36 the slurry 30 onto the current collector 34 to form the wet workpiece 38, the method 114 includes drying 60 the wet workpiece 38 to form the first electrode composition 132. For this embodiment, the sacrificial polymer component may include, for example, polystyrene spheres, latex spheres, polyethyleneimine, and combinations thereof that may act as pore formers or shapers. The sacrificial polymer component may be present in the slurry 30 in an amount of from 0.1 part by weight to 30 parts by weight based on 100 parts by weight of the slurry 30. For example, the sacrificial polymer component may be present in the slurry 30 in an amount of from 0.5 parts by weight to 5 parts by weight, or from 2 parts by weight to 4 parts by weight, based on 100 parts by weight of the slurry 30. At amounts outside the aforementioned range, the first electrode composition 132 may not exhibit the excellent first porosity 100 of the claimed embodiments. However, adjusting an amount of the sacrificial polymer component to from 0.1 part by weight to 30 parts by weight may enable tuning of the first porosity 100 of the electrode 10, 110.

The method 114 also includes, after drying 60, heat-treating 66 the first electrode composition 132 to thereby form the electrode 10, 110. Heat-treating 66 may include cyclizing the binder component, e.g., the polyacrylonitrile. Further, heat-treating 66 may include pyrolyzing the first electrode composition 132 to remove the sacrificial polymer component from the first electrode composition 132.

After drying 60, the sacrificial polymer component may be removed, e.g., burned off, by subsequent processing as set forth in more detail below. During removal, the sacrificial polymer component may enable defining comparatively large pores 48 within the first electrode composition 132. Such comparatively large pores 48 may accommodate volume expansion of the electrode 10, 110 without disturbing a structure of the electrode 10, 110, which can mitigate deterioration of the electrode 10, 110 during electrochemical cycling and improve battery life of the lithium-ion electrochemical cell 12 and device 16. In contrast, comparatively small pores may add stress during silicon particle expansion and may disturb electrical connections between the active material component 26 and the current collector 34.

In another embodiment, although not shown, a method 214 of forming the electrode 10, 110 includes mixing together the conductive filler component 24, the active material component 26, and a water-soluble polymer to form the slurry 30. Further, as set forth above, the method 214 includes casting 36 the slurry 30 onto the current collector 34 to form the wet workpiece 38. The method 214 also includes contacting 42 the wet workpiece 38 with the non-solvent 46 to thereby induce the phase inversion and form the wet electrode composition 32. Further, the method 214 includes drying 60 the wet electrode composition 32 to form the first electrode composition 132 disposed on the current collector 34 and thereby form the electrode 10, 110.

More specifically, the water-soluble polymer may be included in the slurry 30 as a pore-forming additive, and during phase inversion, may dissolve in the non-solvent 46 and enhance a volume and structure of the plurality of pores 48 defined between the first surface 50 and the second surface 52. That is, the water-soluble polymer may be, for example, polyvinylpyrrolidone and may increase the volume of each of the plurality of pores 48 as the water-soluble polymer dissolves in the non-solvent 46, e.g., water, so that the plurality of pores 48 have a finger-like structure that is enlarged during phase inversion. In particular, referring to FIG. 5, as the water-soluble polymer dissolves in the non-solvent 46, some or all of the plurality of pores 48 may have a comparatively large, finger-like structure at both the first surface 50 and the second surface 52. That is, since the water-soluble polymer may be generally hydrophilic, the water-soluble polymer may increase a rate of the phase inversion, which may result in the formation of the comparatively large, finger like structures. As such, for this embodiment, the first electrode composition 132 formed by the method 214 may have the first porosity of at least 60%, e.g., at least 65% or at least 70% or at least 75%, and may have enhanced pore volume and structure.

Therefore, the electrode 10, 110 and lithium-ion electrochemical cell 12 exhibit excellent electrode porosity, energy density, operating life, performance, and charging speed. In particular, contacting 42 the wet workpiece 38 with the non-solvent 46 and inducing the phase inversion process described above and/or defining the plurality of pores 48 after the wet workpiece 38 is dried provides the electrode 10, 110 and lithium-ion electrochemical cell 12 with enhanced performance and fast charging capabilities by allowing for silicon expansion without disturbing electrical connections of the electrode 10, 110 during cycling of the electrode 10, 110 and operation of the lithium-ion electrochemical cell 12. Further, the method 14, 114 is an economical and efficient process to form the electrode 10, 110. In particular, the method 14, 114 may be performed continuously. Therefore, the electrode 10, 110 and lithium-ion electrochemical cell 12 may be economical in terms of manufacturing time and cost and may be scalable to mass production manufacturing operations.

While the best modes for carrying out the disclosure have been described in detail, those familiar with the art to which this disclosure relates will recognize various alternative designs and embodiments for practicing the disclosure within the scope of the appended claims.

1. An electrode for a lithium-ion electrochemical cell, the electrode comprising:
a current collector; and
a first layer formed from a first electrode composition disposed on the current collector and including:
a binder component;
a conductive filler component dispersed within the binder component; and
an active material component dispersed within the binder component and the conductive filler component;
wherein the first electrode composition has:
a first surface; and
a second surface spaced apart from and parallel to the first surface; and
wherein the first electrode composition defines a plurality of pores between the first surface and the second surface having a tailored pore size distribution that includes at least a first pore size and a second pore size that is greater than the first pore size; and
wherein the first electrode composition has a first porosity of at least 60%.

2. The electrode of claim 1, wherein the plurality of pores form a porosity gradient within the first electrode composition between the first surface and the second surface that is configured to minimize an expansion of the electrode and accommodate silicon particle growth during cycling of the lithium-ion electrochemical cell.

3. The electrode of claim 1, wherein the plurality of pores are randomly arranged between the first surface and the second surface.

4. The electrode of claim 1, wherein the first electrode composition has a substantially uniform thickness from the first surface to the second surface.

5. The electrode of claim 1, wherein the binder component is present in the first electrode composition in a first amount; the conductive filler component is present in the first electrode composition in a second amount; and the active material component is present in the first electrode composition in a third amount that is greater than the first amount and the second amount.

6. The electrode of claim 5, further including a second layer formed from a second electrode composition and disposed adjacent the first layer.

7. The electrode of claim 6, wherein the second electrode composition includes a second active material component that is present in the second electrode composition in a fourth amount that is different from the third amount.

8. The electrode of claim 6, wherein the second electrode composition has a second porosity that is different from the first porosity.

9. A method of forming an electrode for a lithium-ion electrochemical cell, the method comprising:
mixing together a conductive filler component, an active material component, a rheology modifier component, and a binder solution that includes a binder component and a solvent to disperse the conductive filler component, the active material component, and the rheology modifier component within the binder solution and form a slurry;
casting the slurry onto a current collector to form a wet workpiece;
contacting the wet workpiece with a non-solvent to thereby induce a phase inversion and form a wet electrode composition; and
drying the wet electrode composition to form a first electrode composition disposed on the current collector and thereby form the electrode;
wherein the first electrode composition has:
a first surface; and
a second surface spaced apart from and parallel to the first surface;
wherein the first electrode composition defines a plurality of pores between the first surface and the second surface having a tailored pore size distribution that includes at least a first pore size and a second pore size that is greater than the first pore size; and
wherein the first electrode composition has a first porosity of at least 60%.

10. The method of claim 8, wherein contacting and inducing the phase inversion includes forming a liquid-like polymer lean phase and a solid-like polymer rich phase in the wet electrode composition as the non-solvent enters the slurry.

11. The method of claim 9, wherein drying includes removing the liquid-like polymer lean phase from the wet electrode composition to thereby define the plurality of pores.

12. The method of claim 10, wherein contacting includes submersing the slurry in a bath including the non-solvent.

13. The method of claim 10, wherein contacting includes misting the slurry with the non-solvent in a chamber for a residence time.

14. The method of claim 8, further including, prior to drying the wet electrode composition, subjecting the wet electrode composition to a vacuum at a temperature of from 20° C. to 150° C.

15. The method of claim 8, wherein drying the wet electrode composition includes pyrolyzing the wet electrode composition at from 350° C. to 950° C. in a nitrogen atmosphere.

16. The method of claim 8, wherein mixing includes blending together the conductive filler component, the active material component, the rheology modifier component, and the binder solution for from 3 minutes to 10 minutes.

17. The method of claim 8, further including, after drying, calendaring the first surface to modify the first porosity of the electrode.

18. A method of forming an electrode for a lithium-ion electrochemical cell, the method comprising:
mixing together a conductive filler component, an active material component, sacrificial polymer component, and a binder solution that includes a binder component and a solvent to disperse the conductive filler component, the active material component, and the sacrificial polymer component within the binder solution and form a slurry;
casting the slurry onto a current collector to form a wet workpiece;
drying the wet workpiece to thereby form a first electrode composition disposed on the current collector, wherein the first electrode composition has:
a first surface; and
a second surface spaced apart from and parallel to the first surface; and
wherein the first electrode composition defines a plurality of pores between the first surface and the second surface having a tailored pore size distribution that includes at least a first pore size and a second pore size that is greater than the first pore size; and
wherein the first electrode composition has a first porosity of at least 60%; and
heat-treating the first electrode composition to thereby form the electrode.

19. The method of claim 18, wherein heat-treating includes cyclizing the binder component.

20. The method of claim 18, wherein heat-treating includes pyrolyzing the first electrode composition to remove the sacrificial polymer component from the first electrode composition.
